(19) United States
(12) Patent Application Publication
(10) Pub. No.: US 2026/0019842 A1
(43) Pub. Date: Jan. 15, 2026

(54) SYSTEM AND METHOD FOR MONITORING AN EVENT IN A NETWORK

(71) Applicant: JIO PLATFORMS LIMITED, Ahmedabad, Gujarat (IN)

(72) Inventors: Aayush BHATNAGAR, Navi Mumbai, Maharashtra (IN); Hardik Navinbhai BAVISHI, Navi Mumbai, Maharashtra (IN); Sandeep BISHT, Kalyan Thane, Maharashtra (IN); Kumar Gaurav SINGH, Panvel, Marashtra (IN); Nilesh SANAS, Navi Mumbai, Maharashtra (IN); Amit Kumar SINGH, Kalyan East, Maharashtra (IN); Raghvendra BHUSHAN, Dist - Thane, Maharashtra (IN); Mangesh Shantaram KALE, Navi Mumbai, Maharashtra (IN); Gaurav JAIN, Maharashtra (IN); Anurag SINHA, Mumbai, Maharashtra (IN)

(73) Assignee: JIO PLATFORMS LIMITED, Ahmedabad, Gujarat (IN)

(21) Appl. No.: 18/992,642

(22) PCT Filed: May 9, 2024
(86) PCT No.: PCT/IN2024/050507

§ 371 Date: Jan. 9, 2025

(30) Foreign Application Priority Data
May 30, 2023 (IN) 202321037376

(51) Int. Cl. H04W 24/08; H04W 4/20; H04W 4/50; H04W 8/18

(52) U.S. Cl. CPC H04W 24/08; H04W 4/20; H04W 4/50; H04W 8/18

(57) ABSTRACT

The present disclosure provides a system and a method for monitoring an event in a network The system comprises a converged network exposure function (CNEF) that uses an interface between a network exposure function (NEF) (304, 404) and a service capability exposure function (SCEF) (306, 406) to monitor various events in the network. Further, the system facilitates an application function (AF) (302, 402) to access the SCEF (306, 406) and manage subscriptions on a single end point via the interface.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to systems and methods for handling an evolved packet core (EPC) and a fifth generation core (5GC) interworking in a telecommunication network. More particularly, the present disclosure relates to a system and a method for monitoring an event in a network.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

The third generation partnership project (3GPP) standards evolve with time and cover aspects of integration and features that a node supports in a telecommunications network. However, lack of explicit description of interaction between fourth generation (4G) and advanced generations (e.g., fifth generation (5G), or beyond) nodes like a service capabilities exposure function (SCEF) and a network exposure function (NEF) may create issues in communication. Further, current systems do not provide information regarding an application function's (AF's) interaction with the NEF and the SCEF through a common application programming interface framework (CAPIF).

There is, therefore, a need in the art to provide a system and a method that can mitigate the problems associated with the prior arts.

### DEFINITION

As used in the present disclosure, the following terms are generally intended to have the meaning as set forth below, except to the extent that the context in which they are used to indicate otherwise.

The term AF as used herein, refers to an application function. The AF is a control plane function within 5G core network, provides application services to the subscriber.

The term UDM as used herein, refers to unified data management. The UDM manages network user data in a single and centralized element.

The term NEF as used herein, refers to network exposure function. The NEF exposes unified application programming interface (APIs) to any other external business applications for interaction with the 5G network functions. It provides interfaces for monitoring, provisioning, and policy/charging functionalities in the 5G network.

The term AMF as used herein, refers to access and mobility management function. The AMF is responsible for managing access and mobility for 5G devices, and it interacts with other network functions such as the UPF (User Plane Function), SMF (Session Management Function), and AUSF (Authentication Server Function).

The term SCEF as used herein, refers to service capability exposure function. The SCEF is a product deployed in a Policy Management network that interacts with Internet of Things (IoT) devices as a machine type communication interworking function (MTC-IWF).

The term HSS as used herein, refers to home subscriber server. The HSS is the main database of the current generation's cellular communications systems. It contains subscriber-related information, such as the authentication information and the list of services to which each user is subscribed.

The term MME as used herein, refers to Mobility Management Entity. The MME is a key component in the 5G core network architecture. It plays a central role in managing the mobility and connection establishment for user devices (UEs) in a 5G network.

### SUMMARY

In an exemplary embodiment, a method for performing monitoring of events in a network is described. The method comprises sending, by an application function (AF), an event monitoring request to a network exposure function (NEF) and communicating, by the NEF, the event monitoring request to a unified data management (UDM). The method further comprises conveying, by the UDM, information associated with the event monitoring request to a home subscriber server (HSS). The method further comprises responsive to failure to convey the information to the HSS, sending, by the UDM, an event monitoring request failure response to the NEF. The method comprises sending, by the NEF, the event monitoring request to a service capability exposure function (SCEF) through an interface an interface between the NEF and the SCEF, responsive to the failure of the UDM. The method further comprises sending, by the SCEF, the event monitoring request response to the NEF via the interface.

In some embodiment, the information associated with the event monitoring request include event monitoring type, maximum number of reports & expiry time of event monitoring.

In some embodiment, the failure response indicates an error that a subscription for the event monitoring is not created at the HSS.

In some embodiment, the AF is configured to provide a maximum detection time, a maximum latency, a maximum response time in the request, number of downlink packets, an idle status indication, a maximum number of reports, a maximum duration of reporting and a periodicity, wherein the maximum detection time indicates a maximum period of time without any communication with a user equipment (UE) after which the AF is configured to be informed that the UE is considered to be unreachable.

In some embodiments, a plurality of events includes loss connectivity, UE reachability, location reporting, a roaming status, communication failure, packet data unit (PDU) session status, number of UEs present in a geographical area, a downlink data delivery status, and a core network (CN) type change.

In some embodiments, the NEF is configured to perform monitoring of event exposure of plurality of network functions (NFs), exposing plurality of monitored events to the AF, a non-internet protocol (IP) data delivery (NIDD) configuration, and a context creation of mobile originated (MO), mobile terminated (MT) and session management (SM).

In some embodiments, when the UE is connected in fourth generation (4G), the HSS is configured to create the event monitoring on a mobility management entity (MME) based on existing public data network (PDN) connectivity request and when the UE is connected in one of advanced generations, a UDM-HSS cluster is configured to provide the event monitoring of an access and mobility function (AMF) as per PDN connectivity request.

In another exemplary embodiment, a system for performing monitoring of events in a network is described. An application function (AF) is configured to send, an event monitoring request to a network exposure function (NEF). The NEF configured to communicate the event monitoring request to a unified data management (UDM). The UDM configured to convey information associated with the event monitoring request to a home subscriber server (HSS). Responsive to the failure of the UDM to convey subscription details to the HSS. the UDM configured to send an event monitoring request failure response to the NEF. The NEF configured to send the event monitoring request to a service capability exposure function (SCEF) through an interface between the NEF and the SCEF, responsive to the failure of the UDM. The SCEF configured to send an event monitoring request response to the NEF via the interface. The event monitoring request response includes information associated with allowing monitoring of the events.

In some embodiment, the information associated with the event monitoring request includes event monitoring type, maximum number of reports and expiry time of event monitoring.

In some embodiment, the failure response indicates an error that a subscription for the event monitoring is not created at the HSS.

In some embodiments, the AF is configured to provide a maximum detection time, a maximum latency, a maximum response time in the request, number of downlink packets, an idle status indication, a maximum number of reports, a maximum duration of reporting and a periodicity, wherein the maximum detection time indicates a maximum period of time without any communication with a user equipment (UE) after which the AF is configured to be informed that the UE is considered to be unreachable.

In some embodiments, a plurality of events includes loss connectivity, the UE reachability, location reporting, a roaming status, communication failure, packet data unit (PDU) session status, number of UEs present in a geographical area, a downlink data delivery status, a core network (CN) type change. Monitoring of events may refer to observing the events to determine the status or information of the events. In an example, the monitored status or information is provided to the user on demand or on a periodic basis. For example, the roaming status may be provided to the user based 'on the user's location or periodically, such as once every six hours. In another example, the core network type change information may be provided when there the UE experiences the change or once in every few hours.

In some embodiments, the NEF is configured to perform monitoring of event exposure of plurality of network functions (NFs), exposing plurality of monitored events to the AF, non-internet protocol (IP) data delivery (NIDD) configuration, and context creation of mobile originated (MO), mobile terminated (MT) and session management.

In some embodiments, when the UE is connected in fourth generation (4G), the HSS is configured to create the event monitoring on a mobility management entity (MME) based on existing PDN connectivity request and when the UE is connected in one of advanced generations, a UDM-HSS cluster is configured to provide the event monitoring of an access and mobility function (AMF) as per PDN connectivity request.

The foregoing general description of the illustrative embodiments and the following detailed description thereof are merely exemplary aspects of the teachings of this disclosure, and are not restrictive.

### OBJECTS OF THE INVENTION

It is an object of the present disclosure to provide a system and a method for monitoring events through a converged network exposure function (cNEF).

It is an object of the present disclosure to provide a system and a method where the cNEF uses an interface between the NEF and a service capability exposure function (SCEF) for monitoring events in a network.

It is an object of the present disclosure to provide a system and a method where monitoring is performed using the SCEF via the interface between the NEF and the SCEF that reduces the complexity for monitoring events in a fourth generation (4G) or a fifth generation (5G) network.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) for implementing a proposed system (108), in accordance with an embodiment of the present disclosure.

FIG. 2 illustrates an exemplary block diagram (200) of a proposed system (108), in accordance with an embodiment of the present disclosure.

FIG. 3 illustrates an exemplary flow diagram (300) for an application function (AF) processing a subscriber request via an interface between a network exposure function (NEF) and a service capability exposure function (SCEF), in accordance with an embodiment of the present disclosure.

FIG. 4A illustrates an exemplary flow diagram (400A) for processing an event monitoring subscription by the interface between the NEF and the SCEF, in accordance with an embodiment of the present disclosure.

FIG. 4B illustrates an exemplary flow diagram (400B) for monitoring of events in the network, in accordance with an embodiment of the present disclosure.

FIG. 5 illustrates an exemplary computer system (500) in which or with which the embodiments of the present disclosure may be implemented.

The foregoing shall be more apparent from the following more detailed description of the disclosure.

### DETAILED DESCRIPTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

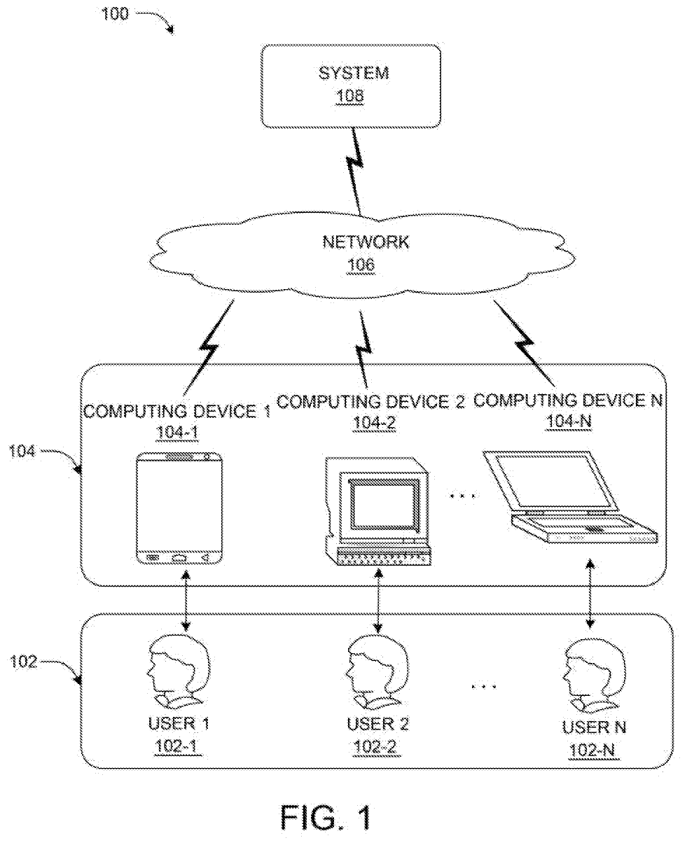

The various embodiments throughout the disclosure will be explained in more detail with reference to FIGS. 1-5.

FIG. 1 illustrates an exemplary network architecture (100) for implementing a proposed system (108), in accordance with an embodiment of the present disclosure.

As illustrated in FIG. 1, one or more computing devices (104-1, 104-2 . . . 104-N) may be connected to a proposed system (108) through a network (106). A person of ordinary skill in the art will understand that the one or more computing devices (104-1, 104-2 . . . 104-N) may be collectively referred as computing devices (104) and individually referred as a computing device (104). One or more users (102-1, 102-2 . . . 102-N) may provide one or more requests to the system (108). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure. In an embodiment the system (108) may be interchangeably referred as a network exposure function and a service capability exposure function interface for handling the one or more requests from the users (102).

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive the one or more requests from the users (102) via the computing devices (104). The one or more requests may include an event exposure subscriber request from the users (102). In an embodiment, the system (108) may monitor primary parameters such as, but not limited to, a loss of connectivity, a UE reachability, and a location report from the various UEs (104). The system (108) may access one or more network functions (NFs) to monitor one or more secondary parameters. The one or more secondary parameters may include, but not limited to, a roaming status, a communication failure, a downlink data notification failure, a packet data unit (PDU) session status, a number of UEs (104) in a geographical area, a core network (CN) type change, and a downlink data delivery status.

In an embodiment, the one or more NFs may include, but not limited to, an access and mobility function (AMF), a unified data management function (UDM), and a session management function (SMF).

In an embodiment, the roaming status may be detected by the system (108) based on the UE (104) status using the UDM. Further, the system (108) may use the AMF and the UDM to determine the communication failure from the UE (104) based on a radio access network (RAN) or a non-access stratum (NAS) failure detection.

In an embodiment, the system (108) may use the AMF and the UDM to determine the downlink data notification failure. The downlink data notification failure may be detected by the system (108) when the UE (104) becomes reachable after a previous downlink data notification failure. The AF may request an idle status indicating the UE (104) reachability.

In an embodiment, the system (108) may use the SMF to determine if the PDU session is established or released.

In an embodiment, the system (108) may use the AMF and determine the number of UEs (104) in a geographical area. The AF may request the system (108) for a last known location of the number of UEs (104) in the geographical area and further determine the number of UEs (104) in a current geographical area.

In an embodiment, the system (108) may use the UDM and determine the CN type change when the UE (104) moves between an evolved packet core (EPC) and a fifth-generation core (5GC). The CN type change indicates a CN type for a UE (104) or a group of UEs (104) while detecting that the UE (104) switches between being served by a mobile management entity (MME) or the AMF or when accepting an event subscription.

In an embodiment, the system (108) may use the SMF to determine the downlink data delivery status where one or more events may be reported to the SMF at a first occurrence of data packets being buffered, transmitted, or discarded.

In an embodiment, the system (108) may access one or more nodes based on the one or more primary parameters and the one or more secondary parameters. The one or more nodes may include, but not limited to, a fourth generation (4G) MME and a fifth generation (5G) home subscriber service (HSS).

In an embodiment, the system (108) may subscribe to a HSS-UDM cluster to process the event exposure subscriber request or an event monitoring request from the users (102). Further, in an embodiment, the system (108) may use the service capability exposure function (SCEF) to create a subscription at the HSS based on the event exposure subscriber request or an event monitoring request from the users (102).

In an embodiment, the system (108) may determine a loss of connectivity where the system (108) may observe that the UE (104) is no longer reachable for a signaling or a user plane communication. Further, in an embodiment, an AF configured in the system (108) may generate a maximum detection time that indicates a maximum period of time without any communication with the UE (104) after which the system (108) may determine that the UE (104) is unreachable.

In an embodiment, the system (108) may determine a UE (104) reachability based on one or more reporting parameters. The one or more reporting parameters may include, but not limited to, a maximum latency, a maximum response time, a number of downlink packets, and an idle status indication.

In an embodiment, the system (108) may determine a location reporting event based one or more detection parameters. The one or more detection parameters may include, but not limited to, a one-time reporting parameter, a maximum number of reports, maximum duration of reporting, and a periodicity parameter. Further, the system (108) may determine a current location or a last known location of the UE (104).

Further, in an embodiment, the UE (104) is communicatively coupled with the network (106). The network (106) may send a connection request to the UE (104). The UE (104) may send an acknowledgment of the connection request to the UE (104). The UE may transmit a plurality of signals in response to the connection request. The network (106) comprises of NFs (e.g., AF, NEF, UDM, SCEF, etc.) for performing monitoring of events in the network.

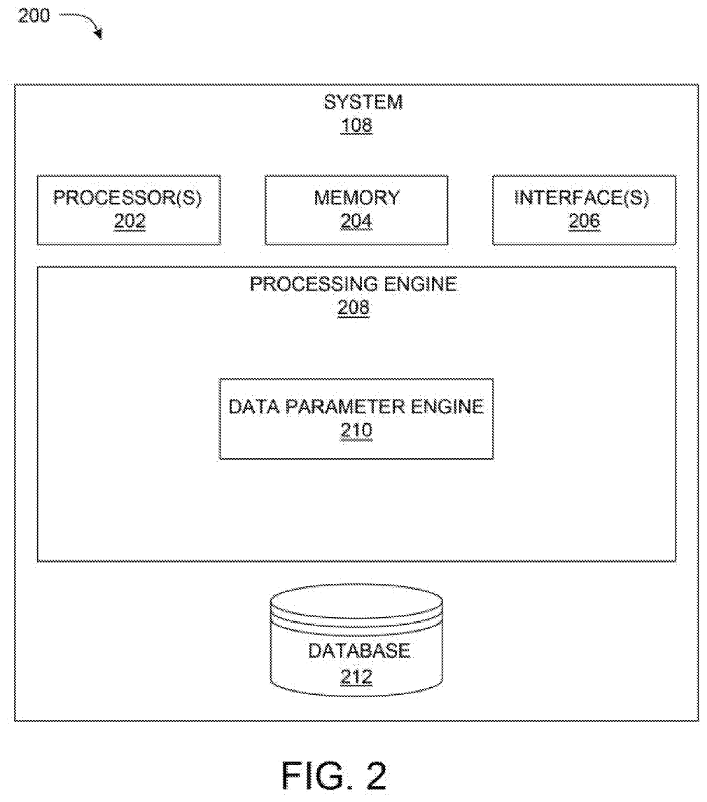

FIG. 2 illustrates an exemplary block diagram (200) of a proposed system (108), in accordance with an embodiment of the present disclosure.

Referring to FIG. 2, in an embodiment, the system (108) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, processing engine(s) (208) and a database (210). Further, the processing engine(s) (208) may include a data parameter engine (212).

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may receive the one or more requests via the data parameter engine (212). The one or more requests may be received from the users (102) via the computing devices (104). The processor (202) may store the one or more requests in the database (210). The one or more requests may include an event exposure subscriber request by the users (102). In an embodiment, the processor (202) may monitor primary parameters such as, but not limited to, a loss of connectivity, a UE reachability, and a location report from the various UEs (104). The processor (202) may access one or more NFs to monitor one or more secondary parameters. The one or more secondary parameters may include, but not limited to, a roaming status, a communication failure, a downlink data notification failure, a PDU session status, a CN type, and a downlink data delivery status.

In an embodiment, the processor (202) may access one or more nodes based on the one or more primary parameters and the one or more secondary parameters. The one or more nodes may include, but not limited to, a 4G MME and a 5G HSS.

In an embodiment, the processor (202) may subscribe to a HSS-UDM cluster to process the event exposure subscriber request or an event monitoring request from the users (102). Further, in an embodiment, the processor (202) may use the SCEF to create a subscription at the HSS based on the even exposure subscriber request or an event monitoring request from the users (102).

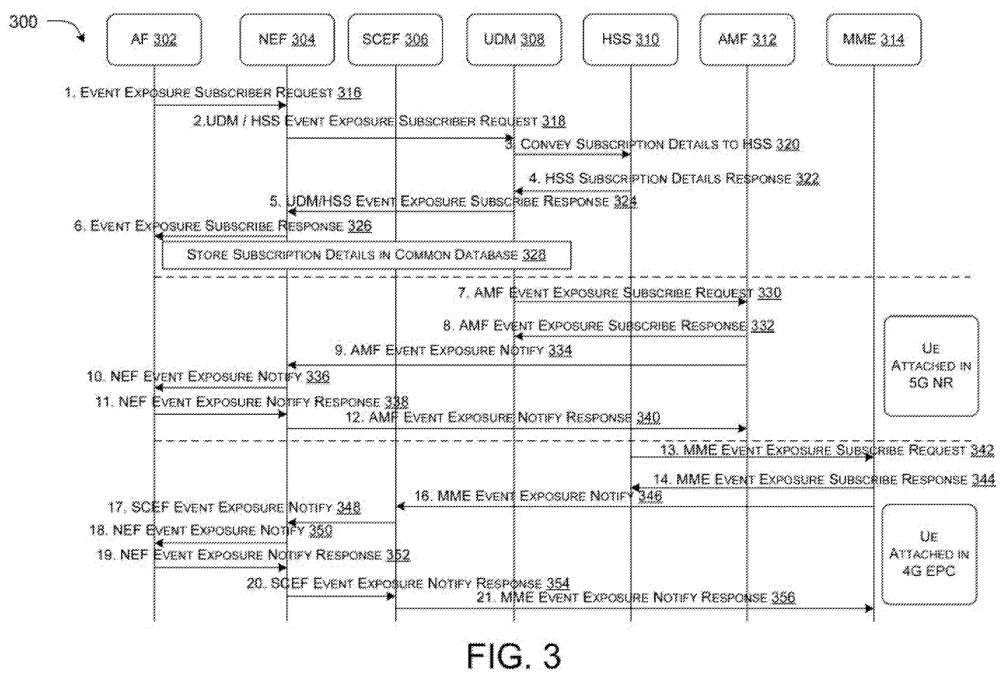

FIG. 3 illustrates an exemplary flow diagram (300) for an AF processing a subscriber request via an interface between a network exposure function (NEF) and a service capability exposure function (SCEF), in accordance with an embodiment of the present disclosure.

As illustrated in FIG. 3, the following steps may be implemented.

At step 316: An AF (302) may send an event exposure subscribe request to an NEF (304). The event exposure subscribe may refer to subscription to an event monitoring request or monitoring the event. The event monitoring request may include request for information or status of various services including the UDM (308) services, the HSS (310) services, the AMF (312) services, the SCEF (306) services, the MMER (314) services, etc.

At step 318: The NEF (304) may send a UDM/HSS subscribe request to a UDM (308) in response to the event exposure subscribe request.

At step 320: The UDM (308) may convey subscription details or information associated with the event monitoring request to an HSS (310). The subscription details include event monitoring type, maximum number of reports and expiry time of event monitoring.

The subscription details may further include services capability server (SCS)/application server (AS) identifier, notification destination address, and one of external identifier, a mobile station international subscriber directory number (MSISDN) or external group identifier. The external identifier or the MSISDN identifies the subscription of an individual UE and the external group identifier points to a group of UEs.

At step 322: The HSS (310), in response to the subscribe request may send an HSS subscription details response to the UDM (308). The HSS subscription details response may include approval or non-approval for subscription an event or event monitoring request.

At step 324: The UDM (308) may send a UDM/HSS subscribe request response to the NEF (304). The UDM/HSS subscribe request response may include information associated with result of subscription to UDM/HSS services including status or information associated subscriber information, service subscription, roaming information, subscriber identity management. authentication and authorization information, policy information, session information, and the line.

At step 326: The NEF (304) may send an event exposure subscribe response to the AF (302). At step 328, the event exposure subscription details may be stored in a common database 328. In an example, the event exposure subscribe response may include information associated with whether the subscription was successful or not.

At step 330: The UDM (308) may send an AMF event exposure subscribe to an AMF (312). The AMF event exposure subscribe may refer to request for information or status of services such as access networks, mobile network connectivity, roaming services, handover information, and location-based services.

At step 332: The AMF (312) may send an AMF event exposure subscribe response to the UDM (308). The AMF event exposure subscribe response may refer to a response from the AMF (312) to the request for information or status of AMF services.

At step 334: The AMF (312) may send an event AMF exposure event notify to the NEF (304).

At step 336: The NEF (304) may send an NEF event exposure notify to the AF (302). The NEF event exposure notify indicates notification that the AF (302) may be provided with events monitoring information or status of services including HSS subscription, the AMF event subscription, etc.

At step 338: The AF (302) may send an NEF event exposure notify response to the AF (302).

At step 340: The NEF (304) may send an AMF event exposure notify response to the NEF (304). In an example, the NEF (304) may send the AMF event exposure notify through an interface between the NEF and a SCEF. In an example, the interface may be referred to as an interface between the NEF (304) and the SCEF (306).

At step 342: The HSS (310) may send an MME event exposure subscribe to an MME (314). The MME event may refer to events associated with the MME including, roaming support, mobility management, bearer management, session management security control and the like.

At step 344: The MME (314) may send an MME event exposure subscribe response to the HSS (310). The MMF event exposure subscribe response may refer to a response from the MME (314) to the request for information or status associated with the AMF services.

At step 346: The MME (314) may send an MME event exposure notify to the SCEF (306). The MME event exposure notify indicates notification that the MME (314) may be provided with events monitoring information or status of services including MME subscription, the MME event subscription, etc.

At step 348: The SCEF (306) may send an SCEF event exposure notify to the NEF (304). The SCEF event exposure notify may refer to a notification associated with the SCEF (314) service.

At step 350: The NEF (304) may send the NEF event exposure notify to the AF (302). The NEF event exposure notify may refer to a notification associated with the NEF services.

At step 352: The AF (302) may send the NEF event exposure notify response to the NEF (304). The NEF event exposure notify response may refer to a response such as an acknowledgement of NEF event exposure notification.

At step 354: The NEF (304) may send an SCEF event exposure notify response to the SCEF (306). The SCEF event exposure notify response may refer to a response such as an acknowledgement of SCEF event exposure notification.

At step 356: The SCEF (306) may send an MME event exposure notify response to the MME (314). The SCEF event exposure notify response may refer to a response such as an acknowledgement of SCEF event exposure notification.

In an embodiment, the AF (302) may access the SCEF (306) via the system (108) and manage subscription through a single end point via the NEF (304). This may reduce the complexity for monitoring the one or more events irrespective of a 4G, an advanced generation (e.g., 5G network) or more advanced generation.

Therefore, the converged NEF may monitor various events in a network. In an example embodiment, the converged NEF may support events monitoring in interworking conditions.

Further, the NEF is configured to perform monitoring of event exposure of plurality of network functions (NFs), exposing plurality of monitored events to the AF, non-internet protocol (IP) data delivery (NIDD) configuration, and context creation of mobile originated (MO), mobile terminated (MT) and session management. In an aspect. Non-IP Data Delivery (NIDD) refers to a communication mechanism used in cellular networks to transmit non-IP (Internet Protocol) data. NIDD may allow the transmission of data using protocols other than IP, enabling efficient delivery of non-IP traffic.

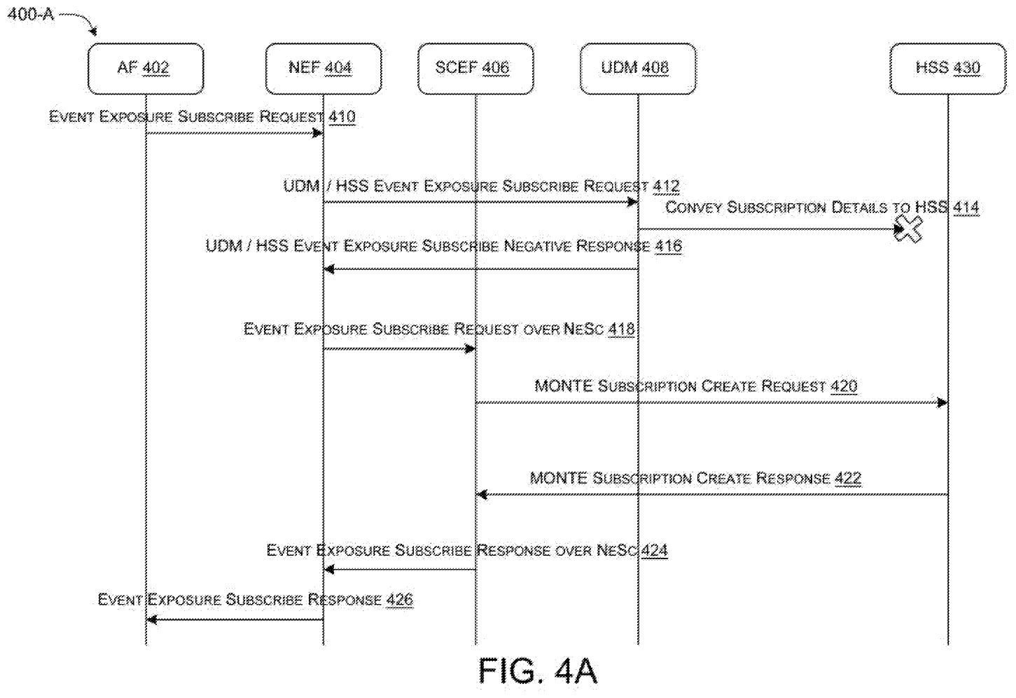

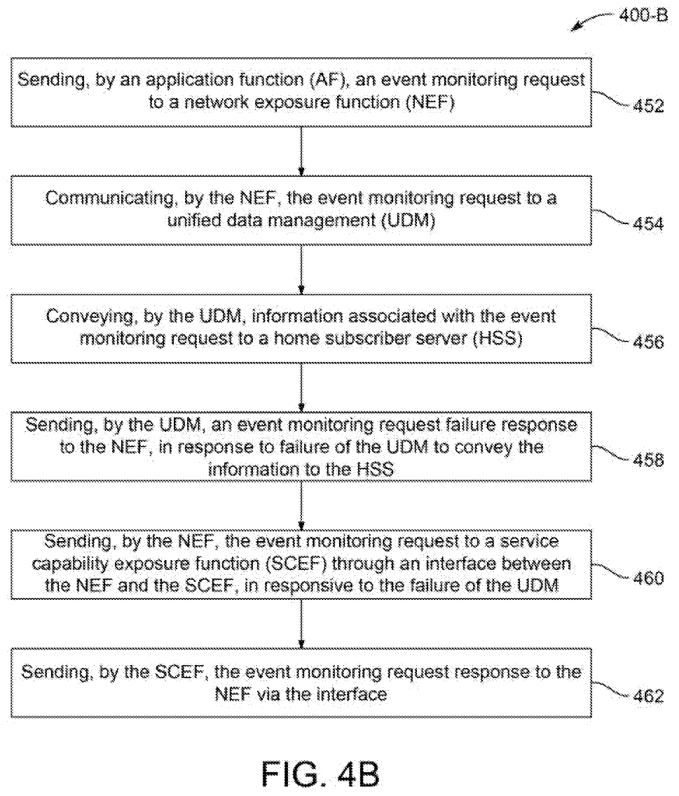

FIG. 4A illustrates an exemplary flow diagram (400A) for processing an event monitoring subscription by an interface between a NEF (404) and a SCEF (406), in accordance with an embodiment of the present disclosure.

As illustrated in FIG. 4A, the following events may be implemented.

At step 410: An AF (402) may send an event exposure subscriber request (also referred to as the event monitoring request) to the NEF (404).

At step 412: The NEF (404) may send a UDM/HSS event exposure subscribe request (an event monitoring request) to a UDM (408).

At step 414: The UDM (408) may send a convey subscription detail (information associated with the event monitoring request) to an HSS (430). The information includes event monitoring type, maximum number of reports and expiry time of event monitoring.

At step 416: The UDM (408) may send a UDM/HSS event exposure subscribe negative response to the NEF (404) responsive to failure of UDM to convey the information.

At step 418: The NEF (404) may send an event exposure subscribe request over an interface to the SCEF (406) responsive to the failure of UDM to convey the information.

At step 420: The SCEF (406) may send an event monitoring subscription create request to the HSS (430).

At step 422: The HSS (430) may send an event monitoring subscription create response (also referred to as the event monitoring request response) to the SCEF (406).

At step 424: The SCEF (406) may send an event exposure subscribe response over the interface to the NEF (404). In examples, the event exposure subscribe response may indicate that the UE is allowed to or provided with event monitoring information.

At step 426: The NEF (404) may send an event exposure subscribe response to the AF (402).

In an embodiment, the AF (402) may subscribe to an event on the NEF (404) specifying a monitoringType with a maximumNumberOfReports and a monitorExpireTime. The AF (402) may receive a converged NEF-identification (ID) during an on-boarding procedure from a common application programming interface framework (CAPIF). The converged NEF is an interface between the NEF and a service capability exposure function (SCEF) for events monitoring in a network.

In an embodiment, after receiving and validating an “Event Exposure” request, the NEF (404) may subscribe to the HSS-UDM cluster in nudm_EventExposure_subscribe irrespective of the UE (104) being in EPC or 5GC with additional parameters like, but not limited to, an epcAppliedInd, a scefDiamHost, a scefDiamRealm, and a cNEF ID.

In an embodiment, for a scenario when the UDM (408) and the HSS (430) are a part of a cluster and the UDM (408) fails to update the HSS (430) about a received event monitoring subscription, the UDM (408) may send a negative response to NEF (404) to inform that the subscription is not created at the HSS (430). On receiving such a response, the NEF (404) may forward the event monitoring subscription to the SCEF (406) over the interface between the NEF (404) and the SCEF (406). Further, the NEF (404) may wait for a response from the UDM-HSS cluster. If the response is positive, the NEF (404) may not send the event monitoring request to the SCEF (406). But, if the NEF (404) receives a negative response with an error indicating that the subscription may not be created at the HSS (430), the NEF (404) may send the request to the SCEF (406) to create the subscription at the HSS (430).

In an embodiment, the UDM (408) may forward the subscription to the AMF (e.g., 312) with a maxReport and an expiryTime. The maxReports are the maximum number of reports that can be generated by the subscribed event. The expiryTime is time after which the subscribed event(s) shall stop generating report and the subscription becomes invalid. The AMF (312) may share an ID with the UDM (408) during the UE attach procedure in a 5GC in Namf_EventExposure_subscribe. If the UE (104) attaches in one of advanced generation (e.g., 5G network), a UDM-HSS cluster may provision the event monitoring of the AMF (312) as per a public data network (PDN) connectivity request. While, in case the UE (104) attaches in the 4G, the HSS (430) may create the event monitoring on the MME (e.g., 314) based on the existing PDN connectivity request.

In an aspect, Namf_EventExposure_subscribe is a service operation used by the consumer NF to subscribe to or modify event reporting for one UE, a group of UE(s) or any UE.

The UDM-HSS cluster refers to the integration or combination of the Unified Data Management (UDM) and the Home Subscriber Server (HSS) functionalities within a telecommunications network architecture. Both UDM and HSS serve as central repositories for subscriber-related data and play critical roles in authentication, authorization, and subscriber management.

In an embodiment, the AMF (312) may send the event monitoring configuration response to the UDM (408) and the UDM (408) may forward the event monitoring configuration response to the NEF (404). For EPC, the HSS (430) may forward the subscription to the MME (314) based on an MME ID shared to the HSS (430) during the UE attach procedure. The HSS (430) may forward the subscription response to the UDM (408) after receiving event subscription response from the MME (314). Further, the UDM (408) may forward the event exposure subscription response to the NEF (404).

In an embodiment, in case of an event monitoring delete request from the AF (402), the converged NEF may initiate a delete request towards the UDM-HSS cluster. If the UE (104) is already attached in 4G, the HSS (430) may initiate an insert subscription data request/insert subscription answer (IDR-IDA) towards the MME (314). If the UE (104) is detached, then the HSS (430) may update the event monitoring in the MME (314) via an update location response/update location answer (ULR/ULA) message when the UE (104) reattaches. While in case of advanced generation (e.g., 5G), the UDM (408) may initiate a “Namf_EventExposure_Unsubscribe” towards the AMF (312) to remove existing the subscription. In a scenario when the HSS (430) and the UDM (408) are not deployed separately, the NEF (404) may forward the delete request to the SCEF (406). The NEF (404) may initiate delete on the UDM (408) and the SCEF (406) may initiate a delete towards the HSS (430) based on the event monitoring create request's response (if creation was successful or not).

“Namf_EventExposure_Unsubscribe” is to remove an existing subscription. In an aspect, the “Namf_EventExposure_Unsubscribe” enables a network function (NF) to unsubscribe to event notifications on its own or behalf of another NF for any event notification. Further, the unsubscribe service operation is invoked by a NF service consumer (e.g. NEF) towards the AMF, to remove an existing subscription previously created by itself at the AMF. The NF service consumer shall unsubscribe to the subscription by using HTTP method DELETE with the URI of the individual subscription resource. The NF Service consumer may send a DELETE request to delete an existing subscription resource in the AMF. On success, the request is accepted, the AMF shall reply with the status code 204 indicating the resource identified by subscription ID is successfully deleted in the response message.

In an embodiment, for 5GC, the AMF (312) may detect the event based on the UE (104) availability and send a notification to the NEF (404) based on a converged NEF-ID received from the UDM (408) during the subscription creation. The converged NEF-ID may be a call-back for forwarding the request to converged NEF clusters of multiple instances. In case of the event monitoring report flow via a service communication proxy (SCP), the converged NEF-ID may be visible in a binding header. For EPC, the MME (314) may detect the event based on the UE (104) and send the notification to the SCEF (406) based on the Converged NEF-ID received from the HSS (430). Further, the SCEF (406) may forward a notification to the NEF (404) over the interface between the NEF (404) and the SCEF (406). The converged NEF-ID may be commonly used by the NEF (404) and the SCEF (406) in the EPC and the 5GC. This ID may be routable in both the 4G and the advanced generation (e.g., 5G, and beyond) networks.

FIG. 4B illustrates an exemplary flow diagram (400B) for monitoring of events in the network, in accordance with an embodiment of the present disclosure.

As illustrated in FIG. 4B, the flow diagram (400B) comprises of following steps:

At step 452, sending, by an application function (AF) (402), an event monitoring request to a network exposure function (NEF) (404).

At step 454, communicating, by the NEF (404), the event monitoring request to a unified data management (UDM) (408).

At step 456, conveying, by the UDM (408), information associated with the event monitoring request to a home subscriber server (HSS) (430). The information associated with the event monitoring request may include event monitoring type, maximum number of reports and expiry time of event monitoring.

At step 458, sending, by the UDM (408), an event monitoring request failure response to the NEF (404), in response to failure of the UDM (408) to convey the information to the HSS (430). The failure response indicates an error that a subscription for the event monitoring is not created at the HSS (430).

At step 460, sending, by the NEF (404), the event monitoring request to a service capability exposure function (SCEF) (406) through an interface between the NEF (404) and the SCEF (406), in responsive to the failure of the UDM (408).

At step 462, sending, by the SCEF (406), the event monitoring request response to the NEF (404) via the interface between the NEF (404) and the SCEF (406).

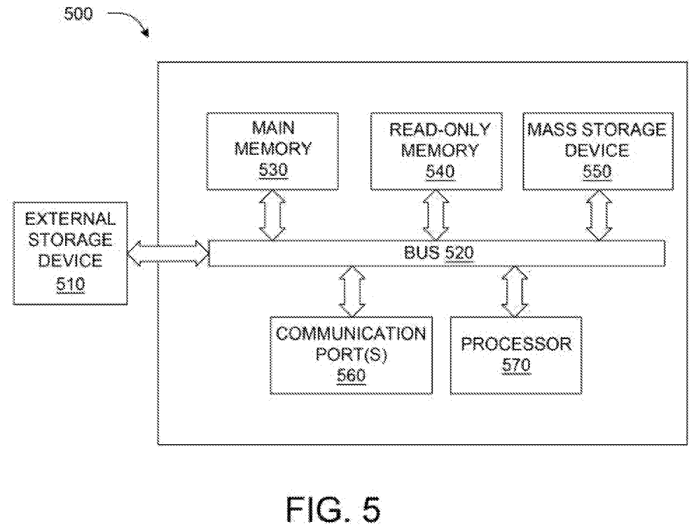

FIG. 5 illustrates an exemplary computer system (500) in which or with which embodiments of the present disclosure may be implemented.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system (500) connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (570) with the other memory, storage, and communication blocks. The bus (520) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method for events monitoring through a converged network exposure function (NEF).

The present disclosure provides a system and a method where the converged NEF uses a newly developed interface between the NEF and a service capability exposure function (SCEF) called as a network exposure function and a service capability exposure function interface for events monitoring in a network.

The present disclosure provides a system and a method where monitoring is performed using the SCEF via the NEF and the SCEF interface that reduces the complexity for events monitoring in a fourth generation (4G) or advanced generations (e.g., fifth generation (5G), or beyond) network.

We claim:

1. A method for performing monitoring of events in a network, the method comprising:
sending, by an application function (AF) (302, 402), an event monitoring request to a network exposure function (NEF) (304, 404);
communicating, by the NEF (304, 404), the event monitoring request to a unified data management (UDM) (308);
conveying, by the UDM (308, 408), information associated with the event monitoring request to a home subscriber server (HSS) (310);
responsive to failure of the UDM (308, 408) to convey the information to the HSS (310), sending, by the UDM (308), an event monitoring request failure response to the NEF (304, 404);
sending, by the NEF (304), the event monitoring request to a service capability exposure function (SCEF) (306, 406) through an interface between the NEF (304, 404) and the SCEF (306, 406), responsive to the failure of the UDM (308, 408); and
sending, by the SCEF, the event monitoring request response to the NEF (304, 404) via the interface, wherein the event monitoring request response includes information associated with allowing monitoring of the events.

2. The method claimed as in claim 1, wherein the information associated with the event monitoring request includes event monitoring type, maximum number of reports and expiry time of event monitoring.

3. The method claimed as in claim 1, wherein the failure response indicates an error that a subscription for the event monitoring is not created at the HSS (310).

4. The method claimed as in claim 1, wherein the AF (302, 402) is configured to provide a maximum detection time, a maximum latency, a maximum response time in request, number of downlink packets, an idle status indication, a maximum number of reports, a maximum duration of reporting and a periodicity, wherein the maximum detection time indicates a maximum period of time without any communication with a user equipment (UE) after which the AF (302, 402) is configured to be informed that the UE is considered to be unreachable.

5. The method claimed as in 1, wherein a plurality of events includes loss connectivity, UE reachability, location reporting, a roaming status, communication failure, packet data unit (PDU) session status, number of UEs present in a geographical area, a downlink data delivery status, and a core network (CN) type change.

6. The method claimed as in 1, wherein the NEF (302, 402) is configured to perform monitoring of event exposure of plurality of network functions (NFs), exposing plurality of monitored events to the AF (302, 402), a non-internet protocol (IP) data delivery (NIDD) configuration, and a context creation of mobile originated (MO), mobile terminated (MT) and session management (SM).

7. The method claimed as in 1, wherein when the UE is connected in fourth generation (4G), the HSS is configured to create the event monitoring on a mobility management entity (MME) based on existing public data network (PDN) connectivity request and when the UE is connected in one of advanced generations of mobile network, a UDM-HSS cluster is configured to provide the event monitoring of an access and mobility function (AMF) as per PDN connectivity request.

8. A system for performing monitoring of events in a network comprising:
an application function (AF) (302, 402) configured to send an event monitoring request to a network exposure function (NEF) (304, 404);
the NEF (304, 404) configured to communicate the event monitoring request to a unified data management (UDM);
the UDM (308, 408) configured to:
convey information associated with the event monitoring request to a home subscriber server (HSS) (310) and
send to an event monitoring request failure response to the NEF (304) responsive to the failure of the UDM to convey subscription details to the HSS (310); and
the NEF (304, 404) configured to send the event monitoring request to a service capability exposure function (SCEF) (306, 406) through an interface between the NEF (304, 404) and the SCEF (306, 406), responsive to the failure of the UDM (308, 408); and
the SCEF (306, 406) configured to send an event monitoring request response to the NEF (304, 404) via the interface, wherein the event monitoring request response includes information associated with allowing monitoring of the events.

9. The system claimed as in claim 8, wherein the information associated with the event monitoring request includes event monitoring type, maximum number of reports and expiry time of event monitoring.

10. The system claimed as in claim 8, wherein the failure response indicates an error that a subscription for the event monitoring is not created at the HSS.

11. The system claimed as in claim 8, wherein the AF is configured to provide a maximum detection time, a maximum latency, a maximum response time in the request, number of downlink packets, an idle status indication, a maximum number of reports, a maximum duration of reporting and a periodicity, wherein the maximum detection time indicates a maximum period of time without any communication with a user equipment (UE) after which the AF is configured to be informed that the UE is considered to be unreachable.

12. The system claimed as in claim 8, wherein a plurality of events includes loss connectivity, the UE reachability, location reporting, a roaming status, communication failure, packet data unit (PDU) session status, number of UEs present in a geographical area, a downlink data delivery status, a core network (CN) type change.

13. The system claimed as in claim 8, wherein the NEF is configured to perform monitoring of event exposure of plurality of network functions (NFs), exposing plurality of monitored events to the AF, non-internet protocol (IP) data delivery (NIDD) configuration, and context creation of mobile originated (MO), mobile terminated (MT) and session management.

14. The system claimed as in claim 8, wherein when the UE is connected in fourth generation (4G), the HSS is configured to create the event monitoring on a mobility management entity (MME) based on existing PDN connectivity request and when the UE is connected in one of advanced generations, a UDM-HSS cluster is configured to provide the event monitoring of an access and mobility function (AMF) as per PDN connectivity request.

15. A user equipment (UE) (104-1-N) communicatively coupled with a network (106), the coupling comprises steps of:
receiving, by the network (106), a connection request;
sending an acknowledgment of the connection request to the UE (104-1-N);
transmitting a plurality of signals in response to the connection request, wherein the network comprising an application function (302), a network exposure function (304, 404), a unified data management (UDM) (308), and a service capability exposure function (SCEF) (306, 406) implementing a method for performing monitoring of events in the network (106) as claimed in claim 1.

16. A computer program product comprising a non-transitory computer-readable medium comprising instructions that, when executed by one or more processors, cause the one or more processors to perform method for monitoring an of events in a network, the method comprising:
sending, by an application function (AF) (302, 402), an event exposure subscriber monitoring request to a network exposure function (NEF) (304, 404);
communicating, by the NEF (304, 404), the event monitoring request to a unified data management (UDM) (308);
conveying, by the UDM (308, 408), information associated with the event monitoring request to a home subscriber server (HSS) (310)
responsive to failure of the UDM (308, 408) to convey the information to the HSS (310), sending. by the UDM (308), an event monitoring request failure response to the NEF (304, 404);
sending, by the NEF (304), the event monitoring request to a service capability exposure function (SCEF) (306, 406) through an interface between the NEF (304, 404) and the SCEF (306, 406), responsive to the failure of the UDM (308, 408); and
sending, by the SCEF, the event monitoring request to the NEF (304, 404) via the interface, wherein the event monitoring request response includes information associated with allowing monitoring of the events.
